(19) United States
(12) Patent Application Publication
(10) Pub. No.: US 2025/0064252 A1
(43) Pub. Date: Feb. 27, 2025

(54) BEVERAGE PREPARATION WITH COMPACT CONDITIONING CHAMBER

(71) Applicant: SOCIETE DES PRODUITS NESTLE S.A., Vevey (CH)

(72) Inventors: MARCEL FANKHAUSER, Toffen (CH); GILLES GAVILLET, Ursy (CH); MIGUEL GORTCHACOW, Lausanne (CH); STEFAN STALDER, Zollikofen (CH)

(21) Appl. No.: 18/722,208

(22) PCT Filed: Dec. 21, 2022
(86) PCT No.: PCT/EP2022/087146

§ 371 Date: Jun. 20, 2024

(30) Foreign Application Priority Data
Dec. 22, 2021 (EP) 21216965.0

(51) Int. Cl. A47J 31/22

(52) U.S. Cl. CPC A47J 31/22

(57) ABSTRACT

A machine (1) is configured for preparing a beverage (4) from an ingredient (5a) in a processing cavity (5) by mixing it with water (4′) and centrifugally driving such ingredient (5a) with the water (4′) about a processing axis (30′). The machine (1) comprises: a rotatable ingredient handling system (10,20) for holding and rotating the flavouring ingredient (5a) and water during centrifugation about the processing axis (30′), the ingredient handling system (10,20) having a beverage outlet (25) and a water inlet (24); and a beverage conditioner (50) in fluid communication with the beverage outlet (25) and downstream thereof, the beverage conditioner (50) comprising a conditioning cavity (51) in which the beverage (4) supplied from the outlet (25) is refined. The conditioning cavity (51) is at least partly off-set relative to the processing cavity (5) along the processing axis (30′).

### FIELD OF THE INVENTION

The field of the invention pertains to beverage preparation machines by centrifuging capsules containing an ingredient of the beverage to be prepared.

For the purpose of the present description, a “beverage” is meant t include any human-consumable liquid substance, such as tea, coffee, hot or cold chocolate, milk, soup, baby food, etc. . . . A “capsule” is meant to include any container such as a packaging for containing a pre-portioned beverage ingredient, e.g. a flavouring ingredient, the packaging forming an enclosure of any material, in particular an airtight or pervious material, porous or non-porous material, e.g. plastic, aluminium, recyclable and/or biodegradable packagings, and of any shape and structure, including soft pods or rigid cartridges for containing the ingredient.

### BACKGROUND ART

Certain beverage preparation machines use capsules containing ingredients to be extracted or to be dissolved and/or ingredients that are stored and dosed automatically in the machine or else are added at the time of preparation of the drink. Some beverage machines possess filling means that include a pump for liquid, usually water, which pumps the liquid from a source of water that is cold or indeed heated through heating means, e.g. a thermoblock or the like.

Especially in the field of coffee preparation, machines have been widely developed in which a capsule containing beverage ingredients is inserted in a brewing device. The brewing device is tightly closed about the capsule, water is injected at the first face of the capsule, the beverage is produced in the closed volume of the capsule and a brewed beverage can be drained from a second face of the capsule and collected into a receptacle such as a cup or glass.

Brewing devices have been developed to facilitate insertion of a “fresh” capsule and removal of the capsule upon use. Examples of such brewing devices are disclosed in EP 1 767 129, WO 2009/043630, WO 2005/004683 and WO 2007/135136. The preparation of a beverage by using centrifugation is also known. Examples of centrifugation processes and corresponding devices are disclosed in WO 2008/148601, WO2008/148650, US 5,566, 605, WO 2013/007776, WO 2013/007779 and WO 2013/007780.

Irrespectively of the extraction process itself it has also been proposed to facilitate the handling of capsules by systems for extracting them, in particular by motorizing the opening and/or closure of the extraction system for inserting and/or removing a capsule. Examples of such systems are for example disclosed in EP 1 767 129, WO 2009/113035, WO 2012/025258, WO 2012/025259, WO 2012/041605, WO 2013/127476, WO 2014/096122, WO 2014/096123 and EP2015185946.9.

The preparation of beverage a by using centrifugation is also known. Such beverage preparation includes: providing a beverage (flavoring) ingredient, e.g. as powder and/or leaves, in a capsule; circulating liquid into the capsule and rotating the capsule at sufficient speed to ensure interaction of the liquid with the ingredient while creating a gradient of pressure of liquid in the capsule. Such pressure increases gradually from the centre towards the periphery of the capsule. As liquid traverses the ingredient, e.g. coffee bed, extraction of the ingredient, e.g. coffee compounds, takes place and a liquid extract is obtained that flows out at the periphery of the capsule. Examples of such systems are disclosed in WO 2008/148601, WO 2013/007776, WO 2013/007779, WO 2013/007780, WO 2017/046294, WO 2017/068134 and WO 2017/202746.

It has been proposed to prepare beverages by centrifugation along a horizontal axis.

WO 2015/173123 and WO 2015/173124 disclose a centrifugal brewing chamber formed between two enclosing parts that are relatively translatable between an open position and a closed position. The enclosing parts cooperate with a pair of jaws that are movable between a capsule holding position to hold a capsule between the enclosing parts in the open position and a capsule release position to release the capsule. The jaws are actuated by a first actuator and a second actuator that are activated by the enclosing parts during their the relative translation. The jaws guide a capsule into a position between the enclosing parts in the open position and immobilize the capsule thereinbetween. Then, when the enclosing parts are translated together to enclose the capsule, the jaws release the capsule so that the brewing chamber is formed about the capsule. The enclosing parts are rotated about a horizontal axis to centrifuge the capsule for preparing the beverage with the ingredient in the capsule. At the end of beverage preparation, centrifugation stops and the enclosing parts are relatively translated to the open position whereby the used capsule is allowed to drop from the enclosing parts. Then the jaws are brought back into their capsule holding position.

WO 2008/148646 and WO 2008/148650 describe a beverage preparation device wherein a flow restriction is created downstream of the receptacle, in particular a capsule, for example, by a valve which opens or enlarges under the pressure created by the centrifuged liquid leaving the receptacle. The higher the rotational speed, the more the valve opens or enlarges. The valve can be formed by a mobile restriction part of the device which is elastically urged against a rim portion of the capsule. In WO 2017/068134 the centrifugal brewing chamber is fitted with an outlet valve that is controlled by an inertia body of the machine rotating with the centrifugal brewing chamber. The valve leads into a collector forming a crema chamber in which the beverage upon undergoing a pressure drop at the valve is refined for dispensing into a user-recipient, e.g. a cup or a mug. Such collection chamber is typically arranged around the centrifugal brewing chamber, as for example disclosed in WO 2020/201469.

### SUMMARY OF THE INVENTION

The invention relates to a machine for preparing a beverage from at least one ingredient. Normally such beverage is then dispensed to a user, e.g. to a user-cup or user-mug.

For instance, the machine is a coffee, tea, chocolate, cacao, milk or soup preparation machine. For example, the machine is arranged for preparing within a beverage processing module that includes an ingredient holder, a beverage by passing hot or cold water or another liquid through the ingredient held in the holder, such as a flavouring ingredient, of the beverage to be prepared, such as ground coffee or tea or chocolate or cacao or milk powder.

Such beverage preparation typically includes the mixing of a plurality of beverage ingredients, e.g. water and milk powder, and/or the infusion of a beverage ingredient, such as an infusion of ground coffee or tea with water. One or more of such ingredients may be supplied in loose and/or agglomerate powder form and/or in liquid form, in particular in a concentrate form. A carrier or diluent liquid, e.g. water, may be mixed with such ingredient to form the beverage. Typically, a predetermined amount of beverage is formed and dispensed on user-request, which corresponds to a portion (e.g. a serving). The volume of such a serving may be in the range of 15 to 1000 ml such as 25 to 600 ml for instance 40 to 250 ml, e.g. the volume for filling a cup or mug, depending on the type of beverage. Formed and dispensed beverages may be selected from ristrettos, espressos, lungos, cappuccinos, café latte, americano coffees, teas, etc. . . . For example, a coffee machine may be configured for dispensing espressos, e.g. an adjustable volume of 20 to 60 ml per serving, and/or for dispensing lungos, e.g. a volume in the range of 70 to 200 ml per serving, and/or for dispensing americanos, e.g. a volume in the range of 150 to 750 ml.

An aspect of the invention relates to a machine for preparing a beverage from a flavouring ingredient in a processing cavity. Such a cavity may be configured for holding the ingredient supplied within a capsule. The beverage is prepared by mixing the ingredient with water and centrifugally driving such ingredient and water about a processing axis.

The centrifugation process for preparing a beverage is known for example from EP 2 000 062, EP 2 155 020, EP 2 152 128, WO 2008/148646, WO 2009/106175, WO 2009/106589, WO 2010/026045, WO 2010/026053, WO 2010/066736, WO 2008/148650, WO 2008/148834, WO 2010/066705, WO 2010/063644, WO 2011/023711, WO 2014/096122 or WO 2014/096123.

During beverage preparation, the processing axis may extend horizontally or at an angle thereto. Such angle may be less than 45 deg., for instance less than 30 dege.g. than 15 deg.

Typically, the machine includes one or more of the following components:
a) a fluid system in fluid communication with the flavouring ingredient during beverage preparation;
b) an in-line heater and/or cooler for thermally conditioning a flow of liquid circulated to the flavouring ingredient or a batch heater and/or cooler for circulating thermally conditioned liquid from the batch heater and/or cooler to the flavouring ingredient;
c) a pump for pumping liquid to the flavouring ingredient, in particular a low pressure pump e.g. within the range of 1 to 5 bar, such as 1.5 to 3 bar;
d) a motor for driving the flavouring ingredient in rotation during beverage preparation;
e) an electric control unit, in particular comprising a printed circuit board (PCB), for receiving instructions from a user via an input user-interface and for controlling the heater and/or cooler, pump and motor(s); and
f) one or more sensors for sensing at least one characteristic selected from characteristics of fluid system, the heater and/or cooler, the pump, a liquid tank, an ingredient collector, a flow of the liquid (e.g. by a flowmeter), a pressure of the liquid and a temperature of the liquid, and for communicating such characteristic(s) to the control unit.

When the flavouring ingredient is supplied within a capsule, the capsule can have a body containing an ingredient and a peripherally projecting flange, e.g. a body in the shape of a cup and a lid covering the mouth of the cup and extending beyond the mouth to form the peripherally projecting flange.

The capsule may have a body that is symmetric or asymmetric, conical or frusto-conical or cylindrical or spherical or hemispherical or frusto-spherical, containing the ingredient, e.g. ground coffee, tea or cacao or another beverage ingredient.

The capsule may be of the type described above under the header “field of the invention”. The capsule may be a capsule that has a container-body, e.g. a generally cup-shaped or hemispherical or hemi-ellipsoidal body, having a flange to which a cover lid (or membrane) is attached, in particular sealed. Typically the capsule contains a beverage ingredient. Examples of suitable capsules are disclosed in WO 2008/148601, WO 2008/148604, WO 2008/148646, WO 2008/148650, WO 2008/148656, WO 2008/148834, WO 2011/141532, WO 2011/141535, WO 2013/072239, WO 2013/072297, WO 2013/072326, WO 2015/044400. The capsule may be of the variety commercialised by Nespresso under the brand Vertuo.

The machine has a rotatable ingredient handling for holding and system rotating the flavouring ingredient, e.g. contained within the abovementioned capsule, and during about water centrifugation the processing axis. The ingredient handling system has at least one beverage outlet and at least one water inlet for supplying the water to the flavouring ingredient.

The handling system may include a first ingredient handler and a second ingredient handler that are movable one relative to the other from:
an ingredient transfer configuration for receiving the flavouring ingredient by the first and second capsule handlers and/or releasing such ingredient from the first and second ingredient handlers; to
an ingredient processing configuration for centrifuging the flavouring ingredient and the water by rotation about the processing axis; and
vice versa.

Upon processing, the ingredient, e.g. contained in a capsule, may be collected in an ingredient (or ingredient capsule) collector downstream the handling system, as for example disclosed in WO 2009/074559 or WO 2009/135869.

The machine includes a beverage conditioner in fluid communication with the t abovementioned at least one beverage outlet and downstream thereof. The beverage conditioner includes a conditioning cavity in which the beverage supplied from the outlet is refined. The conditioning cavity extends about the processing axis and leads into a beverage exit passage, for example into an exit conduit.

For instance, when the beverage supplied from the outlet includes gas a (e.g. air), the beverage conditioner may be configured to refine the mixing, e.g. dispersion, of the gas in the beverage, e.g. to improve the quality of a beverage-gas emulsification. When the beverage is coffee, then the conditioner may be configured to refine the coffee crema.

Typically the beverage conditioner leads to beverage exit passage, e.g. the above beverage exit passage, configured to dispense the beverage to a user receptacle, e.g. a cup or mug.

The machine has a machine frame and/or housing which is stationary when the ingredient handling system is rotated for centrifugation and which supports the ingredient handling system.

The frame and/or housing may comprise or be fixed to a bottom configured to rest on a support surface external to such machine when the ingredient handling system is rotated about the processing axis for centrifugation, e.g. an external support surface formed by a table top, the processing axis being at an angle relative to such bottom in the range of 0° to 80°, for instance of 0° to 45°, such as of 0° to 30°, e.g. of 0° to 15°, typically of substantially 0°.

The frame and/or housing can support a motor that is connected to the ingredient handling system, for instance connected directly or via a transmission such as at least one of belts e.g. toothed belts, gears e.g. spur gears, and connecting rods. Rotation of the ingredient handling system about the processing axis during centrifugation may thus be achieved by such motor.

The conditioning cavity is at least partly off-set relative to the processing cavity along the processing axis. For instance, the processing cavity is off-set by a distance of at least 25% of a total axial length of the conditioning cavity, such as at least 50% of the axial length, for example at least 75% of the axial length. The conditioning cavity may be entirely off-set relative to the processing cavity, e.g. relative to the handling system, along the processing axis.

By providing such an axially off-set arrangement between the conditioning cavity and the processing cavity, the configuration freedom is increased, as for example outlined hereafter.

The diameter of the conditioning cavity may be reduced to a size equal or smaller to the diameter of the processing cavity that may be used to reduce the width and/or height of the machine.

The central portion of the beverage conditioner that is not occupied by the processing cavity may be used to provide further functionalities, such as a beverage overflow management.

The cumulated length axial of the beverage conditioner and processing cavity is increased, typically with a reduction of the maximum diameter thereof, which leads to better distribution of the mass and reduction of the inertia of the beverage conditioner and processing cavity along the length. Hence the stability of the conditioner and processing cavity during centrifugation may be thereby increased, with a reduction of rotation-generated vibrations and/or mechanical stress and/or undesired effect on the beverage quality.

The processing cavity may extend about the processing axis up to a maximum processing distance from the processing axis. The conditioning cavity extends about the processing axis up to a maximum conditioning distance from the processing axis. The conditioning distance is equal to or smaller than the processing distance. For instance the conditioning distance may be in the range of 50 to 100% of the processing distance, such as at least 75%, e.g. at least 85%, for example at least 90% of the processing distance.

Hence, in this configuration, the conditioning cavity does not need to extend around the processing cavity in a manner to correspondingly increase the diameter of the machine around the processing cavity as known from the prior art, e.g. as mentioned above. This may open the possibility to design thinner machines than prior art machines at the processing cavity and close thereto.

The conditioning cavity can be entirely off-set relative to the processing cavity along processing axis. The beverage conditioner may be entirely off-set relative to the rotatable ingredient handling system.

The beverage conditioner may include an overflow cavity that is fluid in communication with the conditioning cavity. Such overflow cavity is advantageously configured for storing beverage prior to its conditioning when the conditioning cavity is full with beverage that is being conditioned.

The overflow cavity can extend from the conditioning cavity towards the processing axis to a distance therefrom that is less than 75%, such as less than 60%, for instance less than 40%, e.g. less than 25%, of a distance spacing the conditioning cavity from the processing axis.

The beverage exit passage may be connected to the conditioning cavity at a level corresponding to a top of the overflow cavity or thereabove.

Thus, the filling of the overflow cavity with unconditioned beverage exceeding the capacity of the conditioning cavity maybe favoured rather than allowing such unconditioned beverage to exit the beverage conditioner via the beverage exit passage without proper conditioning.

The conditioning cavity can be delimited by an outermost substantially cylindrical surface and/or an inner substantially cylindrical surface.

For outermost and such inner instance, such substantially cylindrical surfaces are combined to rotate one surface relative to the other surface about the processing axis during centrifugation.

Such one surface, e.g. the outermost surface, may be stationary relative to the machine frame and/or housing and such other surface, e.g. the inner surface, may be rotatable with the rotatable ingredient handling system during centrifugation. For instance, such other surface is angularly fixed to the ingredient handling system during centrifugation.

The outermost and inner substantially cylindrical surfaces can be sufficiently close one to the other to generate a sheering effect in the beverage contained in the conditioning cavity, such as a couette flow, Taylor flow, Vortex flow or turbulent flow.

The outermost and inner surfaces can be spaced apart by a distance of less than 5 mm, such as less than 3 mm, e.g. less than 2 mm.

The beverage outlet and the beverage conditioning cavity may be fluidically connected by a beverage passage e.g. a beverage conduit.

The beverage conduit may extend at least in part along the processing axis e.g. concentrically therealong.

The beverage conduit can be associated with a valve, such as a centrifugal and/or electric valve, for controlling the flow and/or the pressure of the beverage along the beverage passage, and optionally in the processing cavity and/or in the conditioning cavity.

The processing cavity may have a plurality of beverage outlets peripherally arranged at the processing cavity about the central processing axis.

Each peripherally arranged beverage outlet can be in fluid communication with the beverage passage that extends from the communicating outlet towards the processing axis.

A plurality or all of the beverage outlets can be in fluid communication with the common beverage passage in a funnel-like configuration.

A plurality or all of the beverage outlets may be in fluid communication with a corresponding plurality of beverage conduits that merge together at the central processing axis, for instance to extend along the central processing axis.

The water inlet can be arranged at the processing cavity on or adjacent to the processing axis.

The water inlet may be fluidically connected via an upstream water conduit to a water source e.g. to a water tank or a water distribution network.

The water conduit may extend at least in part along the processing axis, e.g. concentrically or adjacently therealong.

The water conduit can be associated with at least one of: a thermal conditioner, e.g. a heater and/or a cooler, for thermally conditioning the water and, optionally, the beverage conditioner by being fixed thereto or integral therewith; a water driver, e.g. a pump, for driving the water towards the processing cavity; and a sensor for sensing a characteristic of the water, e.g. a flow sensor and/or a temperature sensor and/or a pressure sensor.

The beverage passage and the water conduit may extend adjacently one to another or extend one within the other e.g. concentrically, for instance, the beverage passage surrounding the water conduit or vice versa.

One or more of the beverage outlet(s) and/or the water inlet(s) can be associated with one or more capsule (e.g. inlet and/or outlet) openers, such as capsule piercers.

The conditioning cavity may include at least one surface, such as an inner surface, that is driven with the ingredient handling system when rotated for centrifugation, such at least one surface is for example driven in rotation about the processing axis.

The invention also relates to a system comprising a capsule processing machine, as described above, and a capsule containing the flavouring ingredient.

Another aspect of the invention concerns a method of preparing in the above described machine a beverage from the flavouring ingredient supplied within the capsule into the machine. The method includes:
holding and rotating the capsule with the handling system;
feeding the water via the water inlet into the capsule in the processing cavity and centrifuging the flavouring ingredient with the water and form the beverage; and
releasing the beverage via the beverage outlet towards the conditioning cavity.

The processing cavity extends about the processing axis up to a maximum processing distance from the processing axis and the conditioning cavity extends about the processing axis up to a maximum conditioning distance from the processing axis. The conditioning distance is equal to or smaller than the processing distance.

A further aspect of the invention concerns a use of a capsule as the above described capsule for: a machine as described above, when the machine has the processing cavity configured to hold the capsule; implementing the system as described above; or carrying out the method as described above. The capsule is: held and rotated with the handling system; fed with the water via the water inlet in the processing cavity, the flavouring ingredient being centrifuged with the water whereby the beverage is formed; and configured to release the beverage via the beverage outlet towards the conditioning cavity. The processing cavity extends about the processing axis up to a maximum processing distance from the processing axis. The conditioning cavity extends about the processing axis up to a maximum conditioning distance from the processing axis. The conditioning distance is equal to or smaller than the processing distance.

### BRIEF DESCRIPTION OF THE DRAWINGS

The invention will now be described with reference to the schematic drawings, wherein:

FIG. 1 is a cross-sectional side view of part of a machine that has a centrifugal processing cavity and a conditioning cavity according to the invention;

FIG. 2 is a partly cut-away perspective view of the centrifugal processing cavity and the conditioning cavity shown in FIG. 1; and

FIG. 3 is a perspective view of part of the capsule handling device and of the beverage conditioner of the machine shown in FIG. 1.

### DETAILED DESCRIPTION

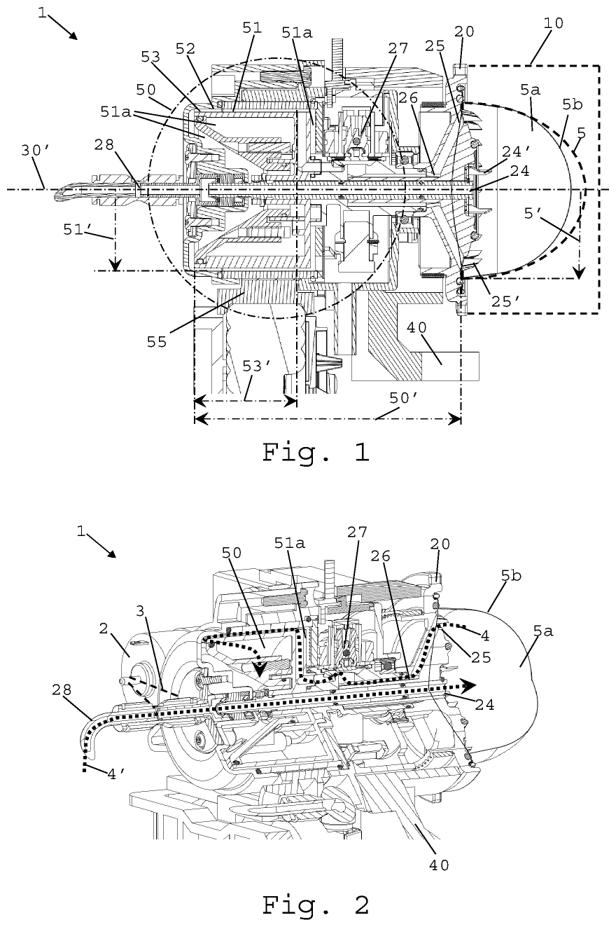

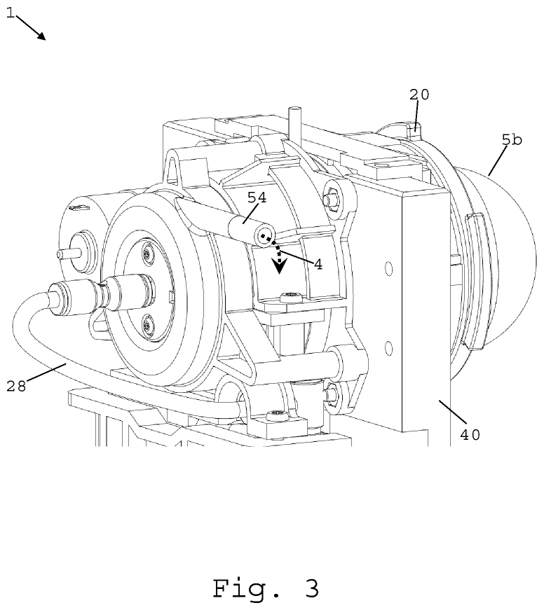

FIGS. 1 to 3 illustrate an exemplary embodiment of a machine 1 in accordance with the invention.

Machine 1 is configured for preparing a beverage 4 from a flavouring ingredient 5a in a processing cavity 5 by mixing ingredient 5a with water 4′ and centrifugally driving such ingredient 5a and water 4′ about a processing axis 30′ to form beverage 4. Processing cavity 5 may be arranged for holding ingredient 5a when supplied within a capsule 5b.

Machine 1 includes a rotatable ingredient handling system 10,20 for holding and rotating flavouring ingredient 5a and water during centrifugation about processing axis 30′. Ingredient handling system 10,20 has at least one beverage outlet 25 and at least one water inlet 24 for supplying water 4′ to ingredient 5a.

System 10,20 may have a first ingredient handler 10 and a second ingredient handler 20 that are movable one relative to the other from: an ingredient transfer configuration for receiving ingredient 5a by first and second capsule handlers 10,20 and/or releasing ingredient 5a from first and second ingredient handlers 10,20; to an ingredient processing configuration for centrifuging ingredient 5a and water by rotation about processing axis 30′; and vice versa.

Machine 1 has a beverage conditioner 50 in fluid communication with at least one beverage outlet 25 and downstream thereof. Beverage conditioner 50 has a conditioning cavity 51 in which beverage 4, supplied from outlet 25, is refined.

Typically, beverage exit passage 54 is configured to dispense beverage 4 to a user receptacle, e.g. a cup or mug.

Machine 1 includes a machine frame and/or housing 40 which is stationary when ingredient handling system 10,20 is rotated for centrifugation and which supports ingredient handling system 10,20.

Frame and/or housing 40 can comprise or be fixed to a bottom configured to rest on a support surface external to machine 1 when ingredient handling system 10,20 is rotated about processing axis 30′ for centrifugation, e.g. an external support surface formed by a table top, processing axis 30′ being at an angle relative to such bottom in the range of 0° to 80°, for instance of 0° to 45°, such as of 0° to 30°, e.g. of 0° to 15°, typically of substantially 0°.

Frame and/or housing 40 may support a motor 2 that is connected to ingredient handling system 10,20, for instance connected directly or via a transmission 3 such as at least one of belts e.g. toothed belts, gears e.g. spur gears, and connecting rods.

Conditioning cavity 51 is at least partly off-set relative to processing cavity 5 along processing axis 30′, optionally off-set by a distance 50′ of at least 25% of a total axial length 53′ of conditioning cavity 51, such as at least 50% of axial length, for instance at least 75% of axial length 53′. For example conditioning cavity (51 is entirely off-set relative to conditioning cavity 51, e.g. relative to the handling system 10,20, along processing axis 30′.

Processing cavity 5 may extend about processing axis 30′ up to a maximum processing distance 5′ from processing axis 30′. Conditioning cavity 51 can extend about processing axis 30′ up to a maximum conditioning distance 51′ from processing axis 30′. Conditioning distance 51′ may be equal to or smaller than processing distance 5′. For example conditioning distance 51′ is in the range of 50 to 100% of processing distance 5′, such as at least 75%, e.g. at least 85%, for example at least 90% of processing distance 5′.

Conditioning cavity 51 can be entirely off-set relative to processing cavity 5 along processing axis 30′. For example, beverage conditioner 50 is entirely off-set relative to rotatable ingredient handling system 10,20.

Beverage conditioner 50 may include an overflow that in communication with cavity 51a is fluid conditioning cavity 51 for storing beverage 4 prior to its conditioning when conditioning cavity 51 is full with beverage 4 that is being conditioned.

Overflow cavity 51a can extend from conditioning cavity 51 towards processing axis 30′ to a distance therefrom that is less than 75%, such as less than 60%, for instance less than 40%, e.g. less than 25%, of a distance spacing conditioning cavity 51 from processing axis 30′.

For example, overflow cavity 51a extends at one or both extremities of conditioner 50 and optionally in a middle part of conditioner 50.

Beverage exit passage 54 may be connected to conditioning cavity 51 at a level corresponding to a top of overflow cavity 51a or thereabove.

Conditioning cavity 51 may be delimited by an outermost substantially cylindrical surface 52 and/or an inner substantially cylindrical surface 53.

For example, machine 1 includes such outermost and inner substantially cylindrical surfaces 52,53 that are rotatable one surface 53 relative to the other surface 52 about processing axis 30′ during centrifugation.

This one surface 52, such as outermost surface 52, may be stationary relative to machine frame and/or housing 40 and this other surface 53, such as inner surface 53, may be e.g. angularly fixed to the ingredient handling system 10,20 during centrifugation.

Outermost and inner substantially cylindrical surfaces 52,53 can be sufficiently close one to the other to generate a sheering effect in beverage 4 contained in conditioning cavity 51, such as a couette flow, Taylor flow, Vortex flow or turbulent flow.

Outermost and inner surfaces 52,53 may be spaced apart by a distance of less than 5 mm, such as less than 3 mm, e.g. less than 2 mm.

Beverage outlet 25 and beverage conditioning cavity 51 may be fluidically connected by a beverage passage 26 e.g. a beverage conduit.

Beverage conduit 26 can extend at least in part along processing axis 30′ e.g. concentrically therealong.

Beverage conduit 26 may be associated with a valve 27, such as a centrifugal and/or electric valve 27, for controlling the flow and/or the pressure of beverage 4 along beverage passage 2, and optionally in the processing cavity 5 and/or in conditioning cavity 51.

Processing cavity 5 can have a plurality of beverage outlets 25 peripherally arranged at processing cavity 5 about central processing axis 30′.

Each peripherally arranged beverage outlet 25 may be in fluid communication with beverage passage 26 that extends from communicating outlet 25 towards processing axis 30′. For example, a plurality or all of beverage outlets 5 are in fluid communication with common beverage passage in a funnel-like configuration.

A plurality or all of beverage outlets 25 may be in fluid communication with a corresponding plurality of beverage conduits 26 that merge together at central processing axis 30′, optionally to extend along central processing axis 30′.

Water inlet 24 can be arranged at processing cavity 5 on or adjacent to processing axis 30′.

Water inlet 24 may be fluidically connected via an upstream water conduit 28 to a water source e.g. to a water tank or a water distribution network.

Water conduit 28 can extend at least in part along axis 30′, e.g. concentrically or adjacently therealong.

Water conduit 28 may be associated with at least one of: a thermal conditioner 55, e.g. a heater and/or a cooler, for thermally conditioning water 4′; a water driver, e.g. a pump, for driving water 4′ towards processing cavity 5; and a sensor for a sensing characteristic of water 4′, e.g. a flow sensor and/or a temperature sensor and/or a pressure sensor.

Beverage passage 26 and water conduit 28 can extend adjacently one to another or extend one within the other e.g. concentrically. For instance, beverage passage 26 surrounds water conduit 28 or vice versa.

One or more of beverage outlet(s) 25 and water inlet(s) 24 may be associated with one or more capsule openers 24′,25′, such as capsule piercers 24′,25′.

Conditioning cavity 51 can include at least one surface, such as an inner surface 53, that is driven with ingredient handling system 10,20 when rotated for centrifugation. For example, such surface 53 is driven in rotation about processing axis 30′.

1. A machine for preparing a beverage from a flavouring ingredient in a processing cavity by mixing said ingredient with water and centrifugally driving such ingredient and said water about a processing axis to form said beverage, such machine comprising:
a rotatable ingredient handling system for holding and rotating said flavouring ingredient and water during centrifugation about the processing axis, the ingredient handling system having at least one beverage outlet and at least one water inlet for supplying said water to said ingredient,
a beverage conditioner in fluid communication with said at least one beverage outlet and downstream thereof, the beverage conditioner comprising a conditioning cavity in which said beverage supplied from the outlet is refined, the conditioning cavity extending about the processing axis and leading into a beverage exit passage e.g. exit conduit; and
a machine frame and/or housing which is stationary when the ingredient handling system is rotated for centrifugation and which supports the ingredient handling system,
the conditioning cavity is at least partly off-set relative to the processing cavity along the processing axis.

2. The machine of claim 1, wherein the processing cavity extends about the processing axis up to a maximum processing distance from the processing axis and in that the conditioning cavity extends about the processing axis up to a maximum conditioning distance from the processing axis, the conditioning distance being equal to or smaller than the processing distance.

3. The machine of claim 1, wherein the conditioning cavity is entirely off-set relative to the processing cavity along the processing axis.

4. The machine of claim 1, wherein the beverage conditioner comprises an overflow cavity that is in fluid communication with the conditioning cavity for storing beverage prior to its conditioning when the conditioning cavity is full with beverage that is being conditioned.

5. The machine of claim 1, wherein the conditioning cavity is delimited by an outermost substantially cylindrical surface and an inner substantially cylindrical surface.

6. The machine of claim 5, which comprises said outermost and said inner substantially cylindrical surfaces that are rotatable one surface relative to the other surface about the processing axis during centrifugation.

7. The machine of claim 1, wherein the beverage outlet and the beverage conditioning cavity are fluidically connected by a beverage passage:
extending at least in part along the processing axis; and
being associated with a valve for controlling the flow and/or the pressure of said beverage along the beverage passage.

8. The machine of claim 1, wherein the water inlet is arranged at the processing cavity on or adjacent to the processing axis.

9. The machine of claim 1, wherein the water inlet is fluidically connected via an upstream water conduit to a water source that:
extends at least in part along the processing axis; and
is associated with at least one of: a thermal conditioner for thermally conditioning said water; a water driver for driving said water towards the processing cavity; and a sensor for sensing a characteristic of said water.

10. The machine of claim 7, wherein a beverage passage and a water conduit extend adjacently one to another or extend one within the other.

11. The machine of claim 1, wherein one or more of the beverage outlet(s) and the water inlet(s) are associated with one or more capsule openers, such as capsule piercers.

12. The machine of claim 1, wherein the conditioning cavity comprises at least one surface that is driven with the ingredient handling system when rotated for centrifugation.

13. A system comprising a capsule processing machine for preparing a beverage from a flavouring ingredient in a processing cavity by mixing said ingredient with water and centrifugally driving such ingredient and said water about a processing axis to form said beverage, such machine comprising:
a rotatable ingredient handling system for holding and rotating said flavouring ingredient and water during centrifugation about the processing axis, the ingredient handling system having at least one beverage outlet and at least one water inlet for supplying said water to said ingredient,
a beverage conditioner in fluid communication with said at least one beverage outlet and downstream thereof, the beverage conditioner comprising a conditioning cavity in which said beverage supplied from the outlet is refined, the conditioning cavity extending about the processing axis and leading into a beverage exit passage e.g. exit conduit; and
a machine frame and/or housing which is stationary when the ingredient handling system is rotated for centrifugation and which supports the ingredient handling system,
the conditioning cavity is at least partly off-set relative to the processing cavity along the processing axis and said capsule containing said flavouring ingredient.

14. A method of preparing in a machine a beverage from a flavouring ingredient in a processing cavity by mixing said ingredient with water and centrifugally driving such ingredient and said water about a processing axis to form said beverage, such machine comprising:
a rotatable ingredient handling system for holding and rotating said flavouring ingredient and water during centrifugation about the processing axis, the ingredient handling system having at least one beverage outlet and at least one water inlet for supplying said water to said ingredient,
a beverage conditioner in fluid communication with said at least one beverage outlet and downstream thereof, the beverage conditioner comprising a conditioning cavity in which said beverage supplied from the outlet is refined, the conditioning cavity extending about the processing axis and leading into a beverage exit passage e.g. exit conduit; and
a machine frame and/or housing which is stationary when the ingredient handling system is rotated for centrifugation and which supports the ingredient handling system,
the conditioning cavity is at least partly off-set relative to the processing cavity along the processing axis, a beverage from a flavouring ingredient supplied within a capsule into the machine, the method comprising:
holding and rotating the capsule with said handling system;
feeding said water via the water inlet into said capsule in the processing cavity and centrifuging the flavouring ingredient with the water and form said beverage; and
release the beverage via the beverage outlet towards the conditioning cavity,
wherein the processing cavity extends about the processing axis up to a maximum processing distance from the processing axis and wherein the conditioning cavity extends about the processing axis up to a maximum conditioning distance from the processing axis, the conditioning distance being equal to or smaller than the processing distance.

15. (canceled)
